(19) United States
(12) Patent Application Publication
(10) Pub. No.: US 2004/0232906 A1
(43) Pub. Date: Nov. 25, 2004

(54) High temperature magnetoresistive sensor

(76) Inventor: David J. Taneyhill, Ladson, SC (US)

Correspondence Address: CALFEE HALTER & GRISWOLD, LLP, 800 SUPERIOR AVENUE, SUITE 1400, CLEVELAND, OH, 44114, US

(21) Appl. No.: 10/440,738

(22) Filed: May 19, 2003

(51) Int. Cl. G01P 3/66; G01B 7/30

(52) U.S. Cl. 324/179; 324/252; 324/207.21; 324/160

(57) ABSTRACT

A sensor package produces a signal in conjunction with an exciter. The sensor package includes a housing and a first, discrete resistive element positioned toward a sensing tip of the housing. The discrete resistive element is also positioned within a sensing range of a target. A resistive module electrically communicates with the discrete resistive element for detecting a magnetoresistive effect.

### BACKGROUND OF THE INVENTION

The present invention relates to wheel speed sensors. It finds particular application in conjunction with high temperature wheel speed sensors and will be described with particular reference thereto. It will be appreciated, however, that the invention is also amenable to other applications.

Wheel speed sensors are used for detecting rotation of wheels on a vehicle. Generally, there are two (2) broad categories into which wheel speed sensors fall (i.e., those employing either active or passive sensors). Active sensors include electronic components that are typically powered by a power source associated with the vehicle. Passive sensors, on the other hand, need no outside power and usually consist of a coil surrounding a magnet material. Both types of sensors are positioned proximate to a circular shaped element having a plurality of teeth (e.g., an exciter or tone ring), which rotates with the wheel hub.

In order to maximize the signal produced by passive sensors, precise fabrication is required so that, upon assembly, a limited clearance between a pole piece associated with the sensor and the teeth of the tone ring is maintained throughout the rotation of the wheel hub. Such precision tends to complicate the fabrication and assembly process and, furthermore, increase the cost associated with manufacturing and assembling passive sensors. Consequently, active wheel sensors, which do not require the same level of precision during fabrication or assembly, have become more desirable.

However, the electronic components included in active sensors are sensitive to higher ambient temperatures. Although active wheel speed sensors may not require as precise positioning relative to the teeth of the tone ring as passive sensors, active wheel speed sensors still must be positioned relatively close to the tone ring (e.g., on or near a spindle). Under certain conditions, this location on the vehicle tends to experience extremely high temperatures.

One of the electronic components included in magnetoresistive-type active sensors includes a plurality of resistors, which are arranged to achieve a magnetoresistive effect. For example, the resistors are included on a silicon chip, which is positioned near a sensing tip within the sensor. During use, the mechanical and electrical configurations of the resistors cause magnetic flux to flow mainly through just one of the resistors (e.g., the flux resistor) on the chip. Furthermore, the resistance of the flux resistor changes as a function of the rate of change of the magnetic flux. Consequently, it is possible to accurately measure the resistance of the flux resistor as the teeth of the exciter ring pass. A speed of a wheel is then determined as a function of the rate of change of the resistance of the flux resistor.

The performance of the silicon chip producing the magnetoresistive effect is negatively affected by higher ambient temperatures. Therefore, there is a need for a component, which is used for achieving the magnetoresistive effect within a speed sensor, that is not negatively affected by higher ambient temperatures.

The present invention provides a new and improved apparatus and method which addresses the above-referenced problems.

### SUMMARY OF THE INVENTION

In one embodiment, a sensor package produces a signal in conjunction with an exciter. The sensor package includes a housing and a first, discrete resistive element positioned toward a sensing tip of the housing. The discrete resistive element is also positioned within a sensing range of a target. A resistive module electrically communicates with the discrete resistive element for detecting a magnetoresistive effect.

In one aspect, the resistive module includes a plurality of additional resistive elements electrically communicating with each other and the first resistive element.

In another aspect, the resistive module includes a second resistive element electrically communicating with the first resistive element, a third resistive element electrically communicating with the second resistive element, and a fourth resistive element electrically communicating with the third resistive element.

In another aspect, the second resistive element is a discrete element; the third resistive element is a discrete element; and the fourth resistive element is a discrete element.

In another aspect, the first, second, third, and fourth resistive elements are configured as a Wheatstone Bridge.

In another aspect, the additional resistive elements are included on an integrated circuit chip.

In another aspect, a ferrous material focuses a magnetic flux caused in the first resistive element as a function of a movement of the target relative to the first resistive element. The first resistive element is positioned along a central axis of the ferrous material so that a current flowing through the first resistive element is perpendicular to the central axis of the ferrous material.

In another aspect, central axes of the additional resistive elements are substantially parallel to the central axis of the ferrous material.

In another aspect, the first resistive element operates up to a temperature of about 210° C.

In another embodiment, a transducer includes an envelope, a first, discrete resistive element, which is positioned toward a sensing tip at a first end of the envelope and within a sensing range of a target, and a means for monitoring a magnetoresistive effect within the first resistive element.

In another embodiment, a method for monitoring a rate at which a target is moving relative to a sensor package includes monitoring a magnetoresistive effect within a first, discrete resistive element through the use of additional resistive elements electrically connected to the first resistive element. The target is moved relative to the first resistive element. A magnetic flux is passed through the first resistive element. A resistance of the first resistive element changes as a function of a rate of change of the flux. A rate at which the target is moving is determined as a function of changes in the resistance of the first resistive element.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a perspective view of a sensor in accordance with the present invention;

FIG. 2 illustrates a perspective view within the sensor shown in FIG. 1 in accordance with one embodiment of the present invention;

FIG. 3 illustrates a configuration of the resistive elements in accordance with one embodiment of the present invention; and

FIG. 4 illustrates a perspective view within a sensor in accordance with a second embodiment of the present invention.

### DETAILED DESCRIPTION OF ILLUSTRATED EMBODIMENTS

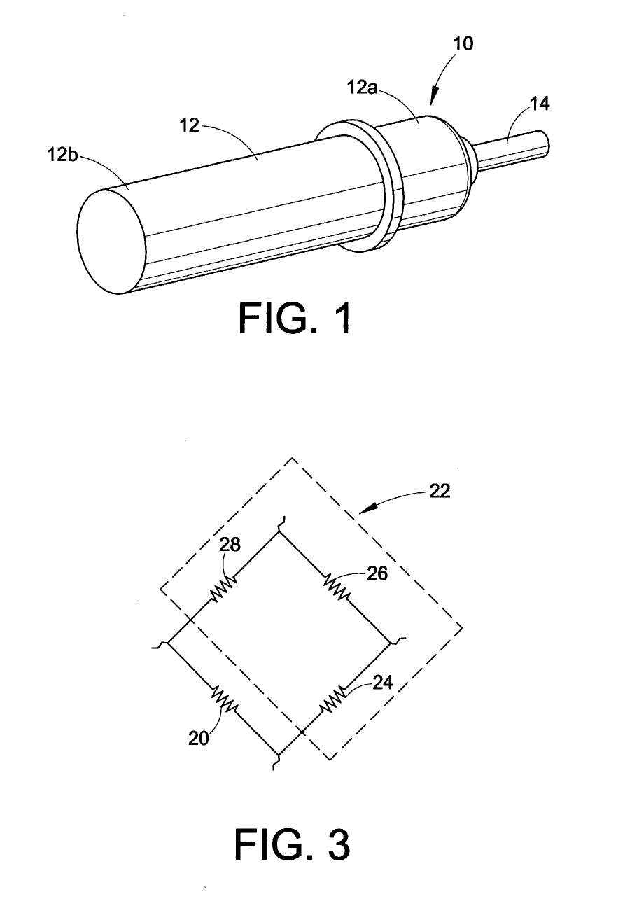

FIG. 1 illustrates a perspective view of a sensor package 10 (transducer) according to one embodiment of the present invention. Although other uses are contemplated, the sensor package 10 is described here as a wheel speed sensor. The package 10 includes a housing 12, which is also referred to herein as an envelope or a cover. A signal transmission means 14 is positioned at a first end 12a of the housing 12. The signal transmission means 14 includes a communication cable, which, in one embodiment, communicates with an anti-lock brake system (ABS) controller (not shown).

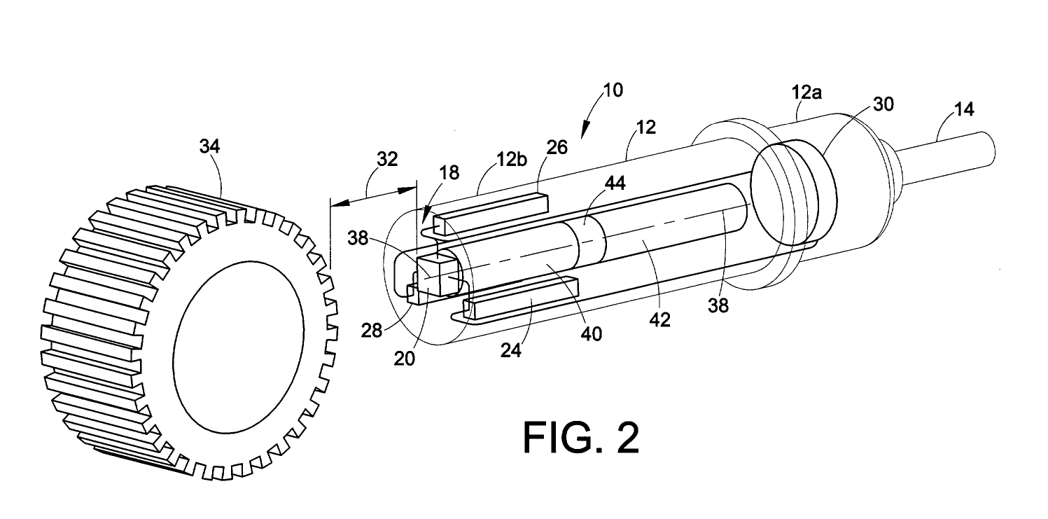

FIG. 2 illustrates a perspective view within the package 10 shown in FIG. 1. In this embodiment, the housing 12 is formed from a metal. However, other embodiments, in which the housing 12 is formed from any other material, are also contemplated. A magnetoresistive means 18 is positioned and secured within the housing 12. The magnetoresistive means 18 includes a plurality of magnetoresistive components electrically and mechanically configured to achieve a magnetoresistive effect.

With reference to FIG. 3, the components of the magnetoresistive means 18 include a first, discrete resistive element 20 (e.g., a resistor), which acts as a sensing element, and a resistive module 22, which includes a plurality of additional resistive elements 24, 26, 28 (e.g., resistors). The resistive elements 20, 24, 26, 28 cooperate to monitor the magnetoresistive effect in the sensing element 20. In the illustrated embodiment, the resistive module 22 includes three (3) additional resistive elements 24, 26, 28 electrically connected in a Wheatstone Bridge configuration to detect the magnetoresistive effect. However, it is to be understood that other embodiments, including any number of resistive elements arranged in different electrical configurations, are also contemplated to achieve the magnetoresistive effect.

A first terminal of the first resistive element 20 is electrically connected to a second terminal of the second resistive element 24 and electronic components 30; a first terminal of the second resistive element 24 is electrically connected to a second terminal of the third resistive element 26 and the electronic components 30; a first terminal of the third resistive element 26 is electrically connected to a second terminal of the fourth resistive element 28 and the electronic components 30; and a first terminal of the fourth resistive element 28 is electrically connected to a second terminal of the first resistive element 20 and the electronic components 30.

In the illustrated embodiment in FIG. 2, the electronic components 30 are positioned at the first end 12a of the housing 12 and communicate with the ABS controller via the transmission means 14. However, it is also contemplated, in other embodiments, that the electronic components are located outside of the housing.

The first resistive element 20 is located toward a second end 12b (sensing tip) of the housing 12 and within a sensing range 32 of a target 34 such that a direction of current flow through the sensing element 20 is perpendicular to a center axis 38 of the housing 12. The sensing element 20 is within the sensing range 32 when a magnetic flux is created in the sensing element 20 as a result of relative movement between the sensing element 20 and the target 34. First and second focusing elements 40, 42, respectively, and a magnet 44 are also positioned along the center axis 38 within the housing 12. The magnet 44 is sandwiched between the focusing elements 40, 42. In one embodiment, each of the focusing elements 40, 42 is a ferrous material capable of focusing and directing electromagnetic energy. For example, the first focusing piece 40 directs electromagnetic energy from the target 34 (e.g., a tooth of an exciter ring (tone ring)) to the magnet 44. The second focusing piece 42 directs (extends) the electromagnetic energy from the magnet 44 back to the target 34.

In the embodiment illustrated in FIG. 2, the second, third, and fourth resistive elements 24, 26, 28 are discrete elements positioned along the focusing pieces 40, 42 such that respective center axes of the resistive elements 24, 26, 28 are parallel to the center axis 38 of the focusing pieces 40, 42. The electrical and mechanical configuration of the resistive elements 20, 24, 26, 28 cause substantially all of a magnetic flux, which is created when the sensing element 20 passes by the target 34, to pass through the sensing element 20 (as opposed to the second, third, and fourth resistive elements 24, 26, 28).

It is to be understood that the maximum operating temperatures of the resistive elements 20, 24, 26, 28 are a function of the sizes of the resistive elements. In one embodiment, the resistive elements 20, 24, 26, 28 would operate up to about 210° C., 185° C., 185° C., and 185° C., respectively.

During use, the sensor package 10 works in conjunction with the target 34 to produce a signal indicating a speed at which the target 34 is moving with respect to the package 10. More specifically, the flux is created when the target 34 moves relative to the sensing element 20. The flux starts, or is created, in the magnet 44. The flux then passes from the magnet 44 to the second ferrous material 42, which focuses the flux back to the sensing element 20. Therefore, the flux travels in a loop through the magnet 44, the second ferrous material 42, the sensing element 20, and then back to the magnet 44. The flux passing through the sensing element 20 changes as a function of the relative movement between the target 34 and the sensing element 20. Furthermore, a resistance of the sensing element 20 changes as a function of a rate of change of the flux. The resistance of the sensing element 20 is measured by the electronic components 30.

In one embodiment, the electronic components 30 determine a rate (speed) at which the target 34 is moving relative to the sensing element 20 as a function of the rate of change of resistance in the sensing element 20. A signal representing the speed of the relative movement between the target 34 and the sensing element 20 is transmitted from the electronic components 30 to the ABS controller. Other embodiments, in which the ABS controller determines the speed of the target 34 as a function of a signal representing the resistance of the sensing element 20, which is received from the electronic components 30, are also contemplated.

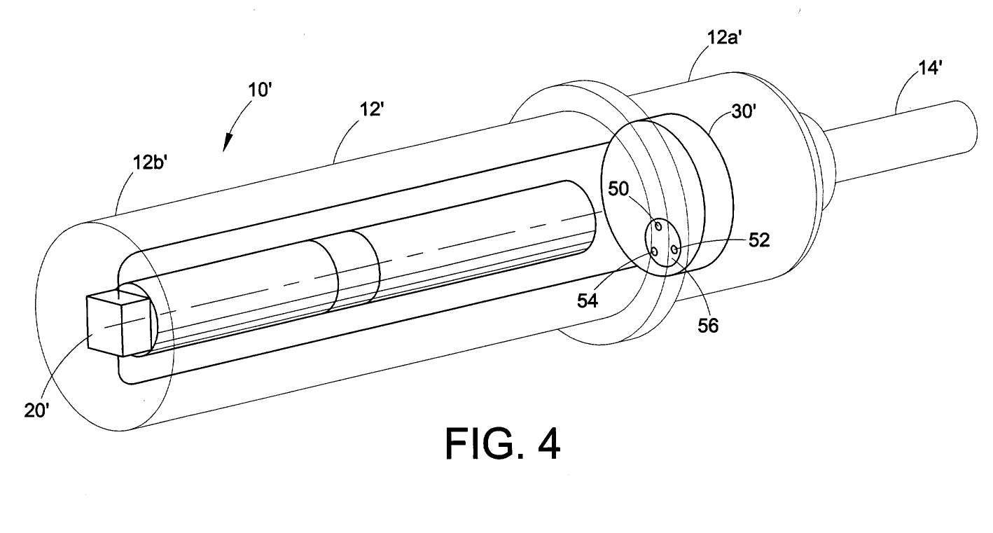

FIG. 4 illustrates another embodiment of the present invention. For ease of understanding this embodiment of the present invention, like components are designated by like numerals with a primed (′) suffix and new components are designated by new numerals.

The sensor package 10′ includes a first resistive element 20′ (a sensing element) that is a discrete component. The second, third, and fourth resistive elements 50, 52, 54 are included on an integrated circuit chip 56 that is included within the electronics 30′. For example, the resistive elements 20′, 50, 52, 54 are configured as a Wheatstone Bridge.

As discussed above, discrete components can withstand higher operating temperatures. Therefore, the sensing element 20′ is capable of withstanding operating temperatures, which may be determined as a function of the size of the sensing element 20′. The second, third, and fourth resistive elements 50, 52, 54 are included on the integrated circuit chip 56, which typically fails at a significantly lower operating temperature than discrete resistive elements (e.g., the sensing element 20′). For this reason, the chip 56 is physically located in a section of the housing, which experiences relatively lower temperatures. For example, the chip 56 is located at the first end 12a′ of the housing 12, where the temperatures are typically significantly lower than where the sensing element 20′ is located (e.g., toward the second end 12b′). Therefore, the operating temperature of the chip 56 is significantly lower than the operating temperature of the sensing element 20′.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/we claim:

1. A sensor package for producing a signal in conjunction with an exciter, the sensor package comprising:
a housing;
a first, discrete resistive element positioned toward a sensing tip of the housing and within a sensing range of a target; and
a resistive module electrically communicating with the discrete resistive element for detecting a magnetoresistive effect.

2. The sensor package as set forth in claim 1, wherein the resistive module includes a plurality of additional resistive elements electrically communicating with each other and the first resistive element.

3. The sensor package as set forth in claim 2, wherein the resistive module includes:
a second resistive element electrically communicating with the first resistive element;
a third resistive element electrically communicating with the second resistive element; and
a fourth resistive element electrically communicating with the third resistive element.

4. The sensor package as set forth in claim 3, wherein:
the second resistive element is a discrete element;
the third resistive element is a discrete element; and
the fourth resistive element is a discrete element.

5. The sensor package as set forth in claim 4, wherein the first, second, third, and fourth resistive elements are configured as a Wheatstone Bridge.

6. The sensor package as set forth in claim 2, wherein the additional resistive elements are included on an integrated circuit chip.

7. The sensor package as set forth in claim 6, wherein the additional resistive elements are configured as a Wheatstone Bridge.

8. The sensor package as set forth in claim 2, further including:
a ferrous material for focusing a magnetic flux caused in the first resistive element as a function of a movement of the target relative to the first resistive element, the first resistive element being positioned along a central axis of the ferrous material so that a current flowing through the first resistive element is perpendicular to the central axis of the ferrous material.

9. The sensor package as set forth in claim 7, wherein:
central axes of the additional resistive elements are substantially parallel to the central axis of the ferrous material.

10. The sensor package as set forth in claim 1, wherein the first resistive element operates up to a temperature of about 210° C.

11. A transducer, comprising:
an envelope;
a first, discrete resistive element positioned toward a sensing tip at a first end of the envelope and within a sensing range of a target; and
means for monitoring a magnetoresistive effect within the first resistive element.

12. The transducer as set forth in claim 11, wherein the means for monitoring the magnetoresistive effect includes:
a resistive module electrically communicating with the first resistive element; and
electronic components for measuring a resistance of the first resistive element.

13. The transducer as set forth in claim 12, wherein the resistive module includes:
a second resistive element;
a third resistive element; and
a fourth resistive element, each of the first, second, third, and fourth resistive elements electrically communicating with the other resistive elements.

14. The transducer as set forth in claim 13, wherein the first, second, third, and fourth resistive elements are configured as a Wheatstone Bridge.

15. The transducer as set forth in claim 13, wherein:
the second resistive element is a discrete element;
the third resistive element is a discrete element; and
the fourth resistive element is a discrete element.

16. The transducer as set forth in claim 13, wherein the second, third, and fourth resistive elements are included on an integrated circuit chip.

17. The transducer as set forth in claim 16, wherein the integrated chip is positioned within the envelope at a location subject to a lower operating temperature than the location of the first resistive element.

18. The transducer as set forth in claim 11, further including:
a ferrous material for focusing a magnetic flux caused in the first resistive element as a function of a movement of the target relative to the first resistive element, the first resistive element being positioned along a central axis of the ferrous material so that a current flowing through the first resistive element is perpendicular to the central axis of the ferrous material.

19. The transducer as set forth in claim 18, wherein:
the means for monitoring the magnetoresistive effect includes a plurality of additional resistive elements;
each of the additional resistive elements electrically communicates with the first resistive element and the other additional resistive elements; and
respective central axes of the additional resistive elements are parallel to the central axis of the ferrous material.

20. A method for determining a rate at which a target is moving relative to a sensor package, the method including:
monitoring a magnetoresistive effect within a first, discrete resistive element through the use of additional resistive elements electrically connected to the first resistive element;
moving the target relative to the first resistive element;
passing a magnetic flux through the first resistive element, a resistance of the first resistive element changing as a function of a rate of change of the flux; and
determining a rate at which the target is moving as a function of changes in the resistance of the first resistive element.

21. The method for determining a rate at which a target is moving as set forth in claim 20, wherein monitoring the magnetoresistive effect includes:
electrically connecting the first and additional resistive elements in a Wheatstone Bridge configuration.

22. The method for determining a rate at which a target is moving as set forth in claim 20, wherein monitoring the magnetic flux includes:
passing a current through the first resistive element in a direction perpendicular to the magnetic flux.

23. The method for determining a rate at which a target is moving as set forth in claim 20, further including:
focusing the magnetic flux via a ferrous material within the sensor package, the first resistive element being positioned along a central axis of the ferrous material so that a current flowing through the first resistive element is perpendicular to the central axis of the ferrous material.

24. The method for determining a rate at which a target is moving as set forth in claim 23, wherein monitoring the magnetoresistive effect includes:
positioning the first resistive element along a central axis of the ferrous material; and
positioning the additional resistive elements along respective axes that are parallel to the central axis.
